(19) United States
(12) Patent Application Publication
(10) Pub. No.: US 2004/0148605 A1
(43) Pub. Date: Jul. 29, 2004

(54) Distributed processing system and method using virtual machine

(75) Inventor: Ki-Yong Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/655,546

(22) Filed: Sep. 5, 2003

(30) Foreign Application Priority Data
Jan. 28, 2003 (KR) 2003-5482

(51) Int. Cl. G06F 9/46

(52) U.S. Cl. 718/100

(57) ABSTRACT

Provided are a multi-functional distributed processing system and method. The system includes a distributed processing server which maintains connection information regarding a plurality of clients, divides a task into task sessions, and transmits to each client a task program storing content of each task session and task data required for each task session; and a plurality of clients, each of which receives the task program through a network using a predetermined protocol, loads the task program onto a virtual machine, receives the task data to run the task program, and transmits a task execution result to the distributed processing server through the network. Whenever a task changes in a distributed processing environment, a distributed processing server generates task programs, which are written in a script language, and transmits them to respective clients, enabling multi-functional distributing processing.

This application claims the priority of Korean Patent Application No. 2003-05482, filed on Jan. 28, 2003, in the Korean Intellectual Property Office, the disclosure of which is incorporated herein by reference in its entirety.

### BACKGROUND OF THE INVENTION

1. Field of the Invention

The present invention relates to a distributed processing system, and more particularly, to a multi-functional distributed processing system and method.

2. Description of the Related Art

A distributed processing system is a system in which a complicated process is divided into small tasks and processed using a plurality of computer systems coupled to a network.

FIG. 1 is a typical distributed processing system.

A distributed processing system comprises a server 110, which is used to manage and control the entire distributed processing system, a plurality of clients 120a through 120n, and a network 130 which is used to connect the server 110 to the plurality of clients 120a through 120n.

A client program 140, which is installed in each of the clients 120a through 120n, is controlled through the network 130 by a server program 150 installed in the server 110 and executes complicated calculations or particular tasks. The server program 150 installed in the server 110, which is coupled to each client program 140, distributes particular tasks and gives a command 160 to each client. The client program 140 executes the given task and transmits the result 170 to the server program 150.

A particular command 160 may be sent by the server program 150 for directing a client to execute a particular task and the client program 140 may respond with the result 170 after the task is executed. The server program 150 and the client program 140 exchange this type of information via a predetermined protocol over the network 130.

However, in the conventional distributed processing system, changing previously established tasks or functions is difficult. That is, in a case where the client program 140 has already been installed and a changed or new task must be executed, reinstallation of the client program 140 is required.

### SUMMARY OF THE INVENTION

The present invention provides a versatile distributed processing system, in which functions are not limited to particular tasks. To execute various tasks, client programs are written in a script language and processed in a virtual machine.

In accordance with an aspect of the present invention, there is provided a distributed processing system, which comprises a distributed processing server that maintains connection information regarding a plurality of clients, divides a task into small tasks, and transmits to each client a task program storing the content of each task and the task data required for each task session; and a plurality of clients, each of which receives the task program through a network using a predetermined protocol, loads the task program onto a virtual machine, receives the task data to run the task program, and transmits the task execution result to the distributed processing server through the network.

The task program is in an exemplary embodiment, written in a script language that can be interpreted by the virtual machine.

The predetermined protocol is in an exemplary embodiment, defined by a script language in the task program.

In accordance with another aspect of the present invention, there is provided a distributed processing method, which comprises a distributed processing server dividing a task into small tasks and transmitting to each client a task program that stores the content of each task session and the task data required for each task session; and each client receiving the task program through a network using a predetermined protocol, loading the task program onto a virtual machine, receiving the task data to run the task program, and transmitting the task execution result to the distributed processing server through the network.

In accordance with yet another aspect of the present invention, there is provided a distributed processing method, which comprises a distributed processing server transmitting to a client a task program and task data required for the task program if a task is defined as requiring distributed processing; loading the task program onto a virtual machine installed in the client; a macro processor performing macro instructions in the loaded task program and a preprocessor performing preprocessing; a scripting engine running the task program; and an interpreter engine manager transmitting the task execution result to a session that requested the task and transmitting information required by the distributed processing server to the distributed processing server.

In accordance with further another aspect of the present invention, there is provided a virtual machine, which executes distributed processing tasks, comprising a main module, which manages the virtual machine and controls other components; an interpreter module, which provides an environment for interpreting and running a task program written in a script language; a designer module which creates a container for storing an external component that is used in the present session to expand the functionality of the virtual machine; a system object module, which includes objects that are provided to the interpreter module; and a task module, which manages the main module and controls a plurality of tasks.

In accordance with still another aspect of the present invention, there is provided a computer-readable medium having embodied thereon a computer program for executing the foregoing method.

### BRIEF DESCRIPTION OF THE DRAWINGS

The above and other features and advantages of the present invention will become more apparent by describing in detail exemplary embodiments thereof with reference to the attached drawings in which:

FIG. 1 shows a typical distributed processing system;

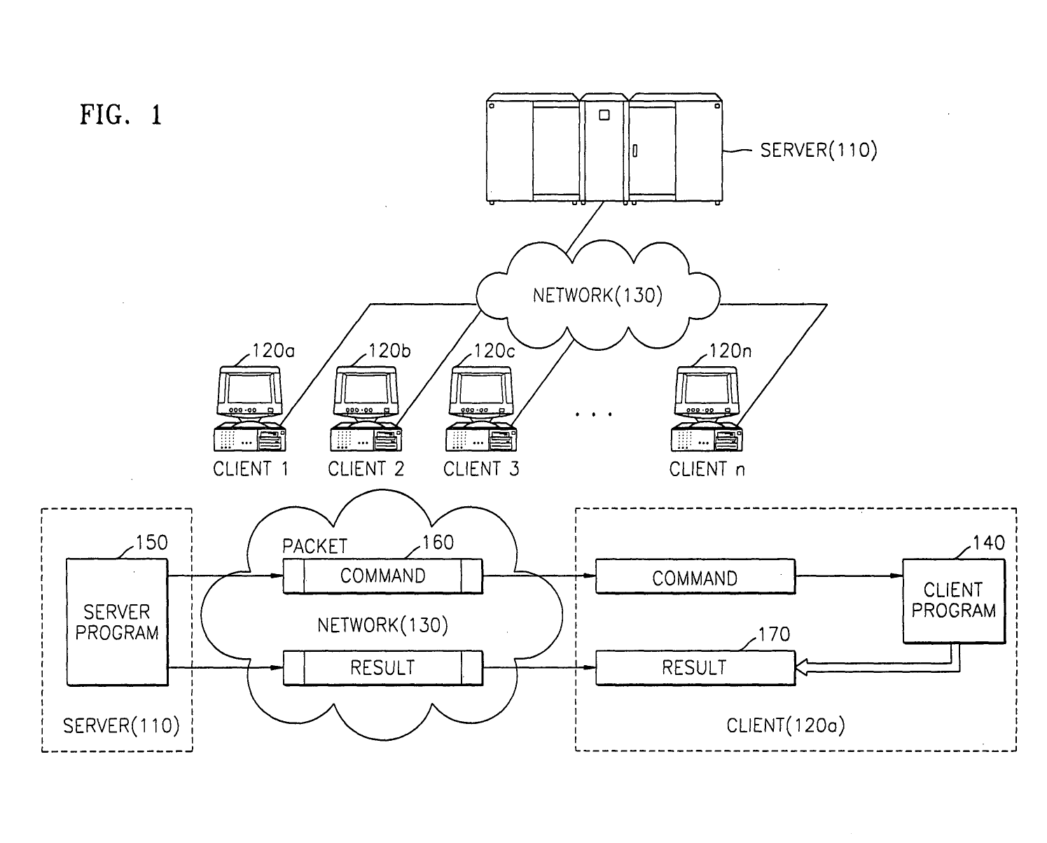

FIG. 2 shows the flow of data in a distributed processing system according to the present invention;

FIG. 3 is a detailed block diagram of a virtual machine;

FIG. 4 is a flowchart illustrating a distributed processing method according to the present invention;

FIG. 5 explains distributed processing using the relationship between the virtual machine and applications according to the present invention; and

FIG. 6 explains distributed processing in more detail.

### DETAILED DESCRIPTION OF THE INVENTION

The structure and operation of a distributed processing system and a method using a virtual machine according to the present invention will be described more fully with reference to the accompanying drawings, in which exemplary embodiments of the invention are shown.

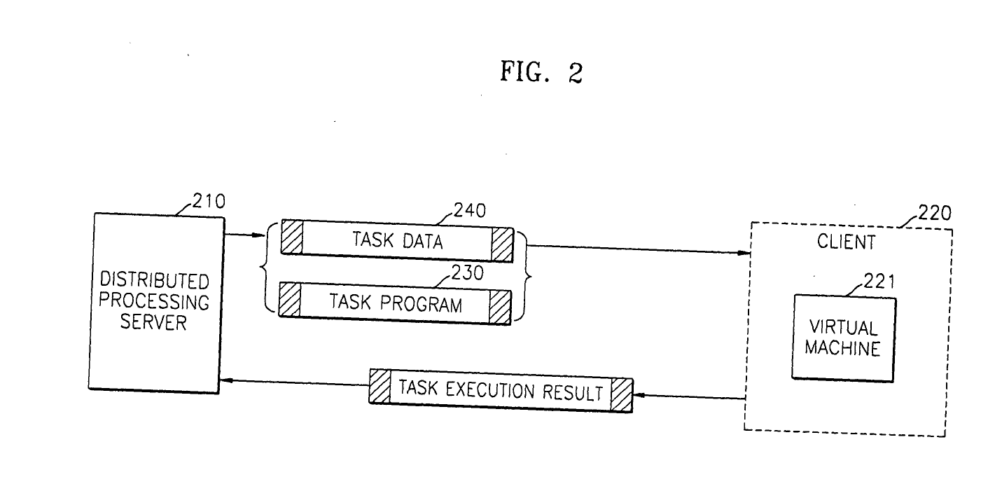

FIG. 2 shows the flow of data in a distributed processing system according to the present invention.

A distributed processing server 210 maintains connection information regarding each client. Once a task is identified for execution in the distributed processing system, the task is divided into small tasks and each of the small tasks is allocated to each client. That is, the distributed processing server 210 transmits a task program 230 and task data 240 to a client 220.

A virtual machine 221 is included in the client 220. The client 220 receives the task program 230 through the network and loads the task program 230 onto the virtual machine 221. The client 220 also receives the task data 240 needed to run the task program 230. After running the task, the client 220 transmits the task execution result through the network to the distributed processing server 210.

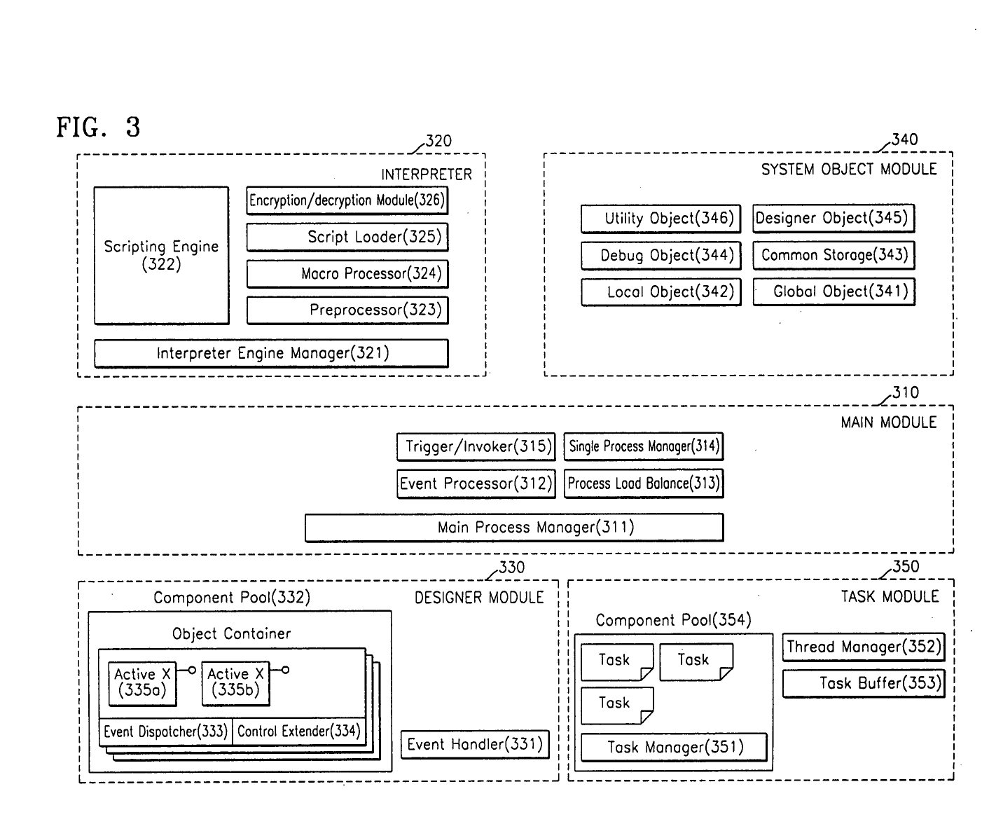

FIG. 3 is a detailed block diagram of the virtual machine 211.

The virtual machine comprises a main module 310, an interpreter module 320, a designer module 330, a system object module 340, and a task module 350.

The main module 310 manages the entire virtual machine and controls the other components. The main module 310 includes a main process manager 311, an event processor 312, a process load balance 313, a single process manager 314, and a trigger/invoker 315.

The main process manager 311 manages tasks, which are written in a script language and divided into task sessions. The main process manager 311 also manages a script interpreting process for each task session. Since each session is affected by an application object that manages all of the sessions, it reports its state to the application object. Thus, the application object controls processing for each session. Objects, which are dynamically bound in each session, create events. The event processor 312 receives the events from each session and transmits them to the interpreter module 320 so that the events can be interpreted. Here, binding refers to creating an internal definition usable in a session. Each of the events is interpreted in the interpreter module 320.

The process load balance 313 adjusts the load of each process. That is, the process load balance 313 adjusts the process load so that excessive load is not allocated to any one process. The single process manager 314, the manager bound in each session object, executes a script interpreting process for one session.

The interpreter module 320 provides an environment for running the task programs. The interpreter module 320 includes an interpreter engine manager 321, a scripting engine 322, a preprocessor 323, a macro processor 324, a script loader 325, and an encryption/decryption module 326.

The interpreter engine manager 321 interprets a task that is requested by the single process manager 314, which is the manager bound in each session object. A single process manager 314 manages one task session, thus creating an environment where respective tasks can be independently executed. The scripting engine 322 runs a task program written in a script language. The preprocessor 323 processes syntax used in a virtual machine. That is, the preprocessor 323 can process code unused in a conventional virtual machine language, thus expanding the functionality of the virtual machine. The macro processor 324 interprets a macro code registered therein.

The script loader 325 reads an original file containing a task that will be executed and converts the original file to a script-source-type file so that the scripting engine 322 can execute the task. The original file may be received from a distributed processing server or other storage devices or local discs connected to the Internet. Alternatively, the distributed processing server may transmit to the script loader only information regarding the storage locations of the original files. Also, an encryption module may be applied according to the file type. The encryption/decryption module 326 performs an encryption and a decryption operation to maintain the security of the interpreter module 320.

The designer module 330 is used as a container for storing external components. The external components are used in the current session for expanding the functionality of the virtual machine. Also, one session creates one basic container. Each of the components, created in the basic container, is called a name and can be accessed by that name. The called name is described in a script language. The design module 330 may store various external components, such as an Internet access function unit, a function unit for performing a complicated operation and reporting the operation result, a figure interpreting function unit, and the like.

The designer module 330 includes an event handler 331 and a component pool 332. The component pool 332 consists of a plurality of object containers. Each of the object containers includes an event dispatcher 333, a control extender 334, and Active X components 335a and 335b.

The event dispatcher 333 receives events created by components, such as the Active X components 335a and 335b, and transmits them to the event handler 331. The control extender 334 enables components to create events. The event handler 331 creates an appropriate event and inserts the event in an event queue, which is loaded in the interpreter module 320. The created event is transmitted to the interpreter module 320. Various components can be disposed in the object container, which is prepared in each session. An object container can be accessed by each name from the interpreter module 320 included in each session.

The system object module 340 includes those objects provided to the interpreter module 320 by the virtual machine. That is, the system object module 340 includes a global object 341, a local object 342, a common storage 343, a debug object 344, a designer object 345, and a utility object 346.

The global object 341 is called an application object in the interpreter module 320. The global object 341 is used throughout the entire virtual machine and is commonly accessed by respective sessions (or processes). The global object 341 is used to manage basic processes and create common global variables/objects. Also, the global object 341 carries out process control, creation of and access to storage of common global variables, and creation of and access to storage of common global objects.

The local object 342 is called a session object in the interpreter module 320. The local object 342 manages one task session. That is, the local object 342 carries out loading and execution of a script, creation of a system object, registry access, creation of and access to storage of a common variable, creation of and access to storage of a common object, collection of an object, invoker registration, macro registration, creation of and access to a timer object, and message transmission.

The common storage 343 is data storage used in the virtual machine. The common storage 343 binds an external component and provides a component interface to an application. The debug object 344 is used to detect task processing, a result, or an error of a task executed in the virtual machine. The designer object 345 allows the interpreter module 320 to utilize a user interface function provided by the virtual machine. A user can construct interfaces and process user events through the designer object 345. The utility object 346 provides basic functions and subroutines to the interpreter module 320.

The task module 350 manages the main process manager 311 and respective tasks. A task is registered as a register process function, and each defined task is managed by a task manager 351 and executed by a thread manager 352. A task buffer 353 stores tasks, and the component pool 354 includes several tasks and several task managers 351.

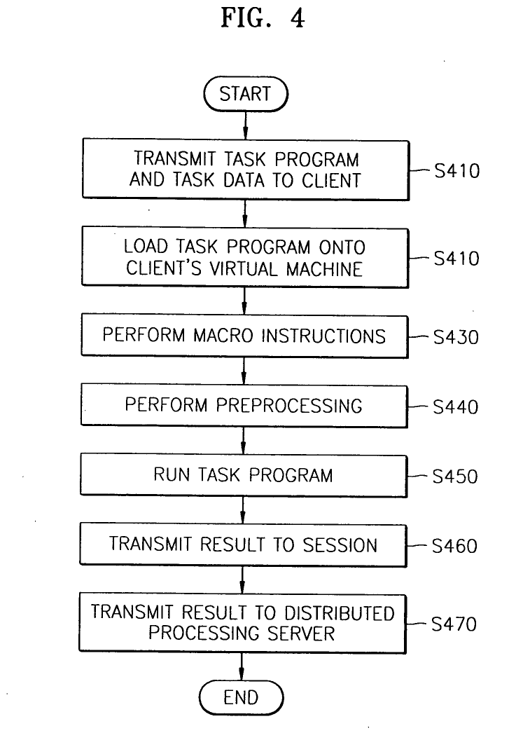

FIG. 4 is a flowchart illustrating a distributed processing method of the present invention.

If a task is defined as requiring distribution processing, a distributed processing server transmits to a client a task program written in a script language and task data required for the task (S410). The task program is loaded onto a virtual machine installed in a computer of the client (S420). A macro processor performs the macro instructions in the loaded task program (S430), and then a preprocessor performs preprocessing (S440). A scripting engine runs the task program by processing the corresponding script language (S450), and an interpreter engine manager transmits the run result to the session requesting the task (S460). Respective task programs have expanded the functionality using components provided by a system object module.

Also, during the execution of the task, a main process manager manages processing of respective task events and executing processes. The main process manager requests and receives the needed data or needed task programs from the distributed processing server or other clients. Finally, information required by the distributed processing server or the task execution result is transmitted to the distributed processing server (S470).

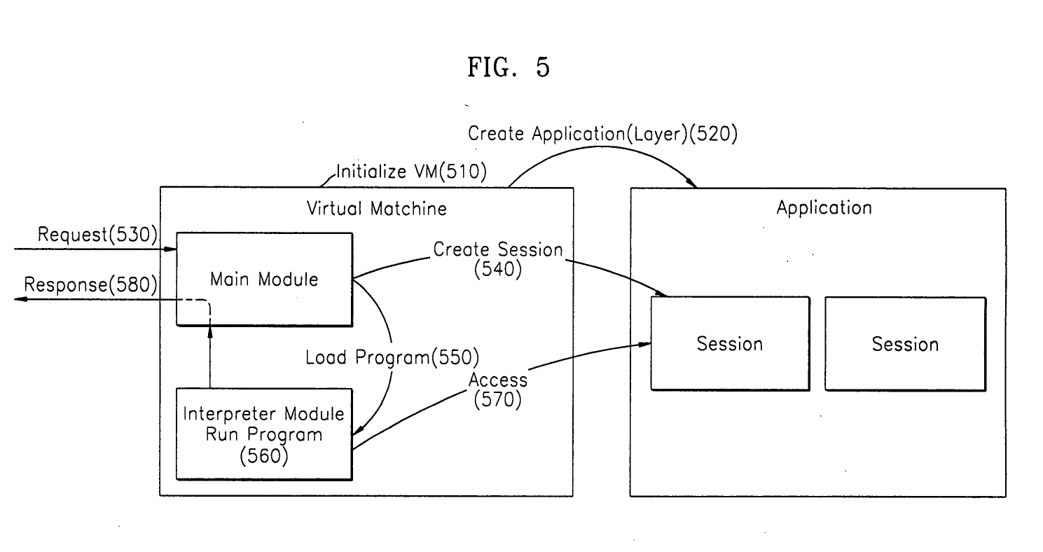

FIG. 5 explains distributed processing using the relationship between a virtual machine and an application.

To begin with, a virtual machine is initialized (510). Next, the virtual machine creates an application (520). If the virtual machine receives a task request along with a task program and task data (530), a main module of the virtual machine creates a session in the application (540). Then, the task program is loaded into an interpreter module (550) and then the task program is run (560). The task execution result of the program is transmitted to the session (570). Then, the result of the task program is transmitted to the distributed programming server through the main module (580).

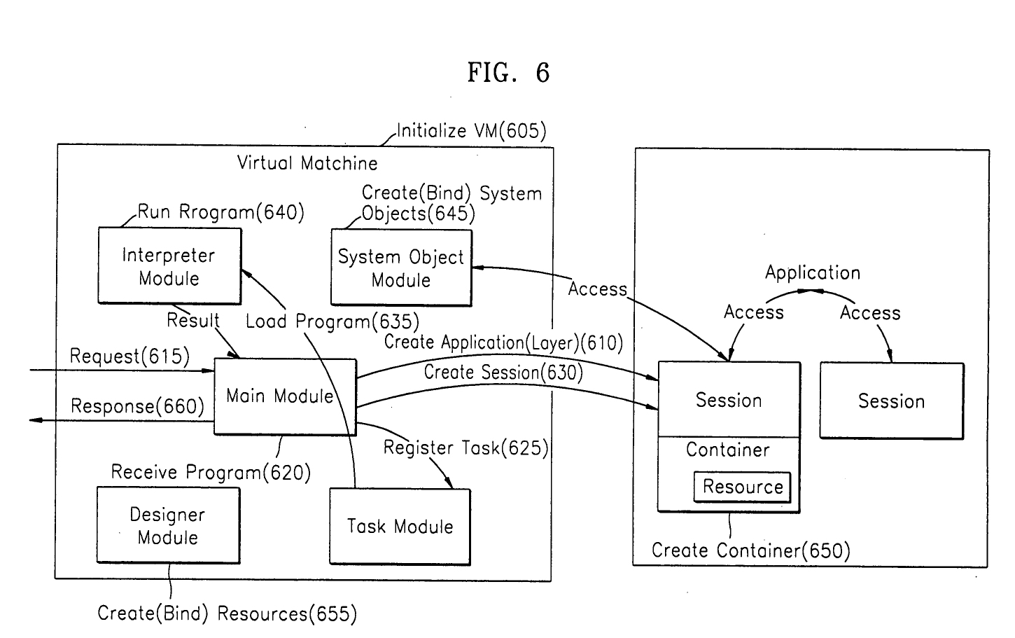

FIG. 6 explains the distributed processing in more detail.

Relationships between respective modules and creation of an application will be described in detail with reference to FIG. 6.

(1) A virtual machine is initialized (605). Memory that the virtual machine will use is secured and a preparation process for allocating a region to each session is executed.

(2) A main module creates an application (610).

(3) The virtual machine receives a task request, along with a task program and task data, from a distributed processing server (615).

(4) A main module receives the task program (620).

(5) A task is registered in a task module for execution (625). That is, a register process is executed. During this process, the contents of tasks are collected or put on a waiting list. The main module sorts the tasks by referring to the waiting list for executing tasks.

(6) The main module creates a session in the application (630).

(7) A task module transmits the task program to an interpreter module (635).

(8) The interpreter module runs the task program (640).

(9) A system object module creates and binds a system object (645). That is, when a session is initialized, local objects including defined memory and functions used in the session are bound in the session. Here, binding refers to connecting the local objects.

(10) A container is created (650). A container is the environment for using a client resource (or an object).

(11) A designer module creates and binds a resource (655). The process of defining a client resource in the container is executed by the designer module. The designer module defines a client resource and addresses the name used in the session. The preceding process is called “binding.”

For example, a binding process is as follows. When an Internet connection resource exists in a client, the contact resource is bound in a container through the designer module. Next, an attribute value of the bound resource is adjusted. That is, an Internet address or a protocol is set. Once the bound resource is called an internally usable name (e.g., InternetComponent), it can be used in the name of InternetComponent in a script for a session (e.g., InternetComponent.Connect “URL”).

(12) The result of the task program, obtained after running the program in the interpreter module, is transmitted to a main module and a server (660).

This invention may be embodied in a general purpose digital computer by running a program from a computer usable medium, including but not limited to storage media such as magnetic storage media (e.g., ROMs, floppy discs hard discs, etc.), optically readable media (e.g., CD-ROMs, DVDs, etc.) and carrier waves (e.g., transmissions over the Internet). The computer readable recording medium can be dispersively installed in a computer system connected to a network, and stored and executed as computer readable code in a distributed computing environment.

As described above, according to the present invention, a multi-functional distributed processing system is provided. Thus, whenever a task changes in a distributed processing environment, a distributed processing server generates task programs, which are written in a script language, and transmits them to respective clients, enabling multi-functional distributed processing. Also, each client program is dynamically run by a virtual machine and can dynamically change the task content.

Also, the distributed processing server and distributed clients communicate with each other in a manner defined by a task program, which is described in a script language rather than by a fixed protocol, and can be functionally expanded. Furthermore, the clients do not only execute fixed operations or particular tasks but also solve various problems using functional resources.

While the present invention has been described in connection with specific and exemplary embodiments thereof, it is capable of various changes and modifications without departing from the spirit and scope of the invention. It should be appreciated that the scope of the invention is not limited to the detailed description of the invention hereinabove, which is intended merely to be illustrative, but rather includes the subject matter defined by the following claims.

What is claimed is:

1. A distributed processing system comprising:
a distributed processing server which maintains connection information regarding a plurality of clients, divides a task into small tasks, and transmits to each client a task program, each of the clients storing respective content of each task session and respective task data required for each of the small tasks, wherein one of the plurality of the clients receives a first task program through a network using a predetermined protocol, loads the first task program onto a virtual machine, receives first task data to run the first task program, and transmits a first task execution result to the distributed processing server through the network.

2. The system of claim 1, wherein the first task program is written in a script language that can be interpreted by the virtual machine.

3. The system of claim 1, wherein the predetermined protocol is defined by a script language in the first task program.

4. The system of claim 1, wherein the virtual machine includes:
a main module which manages the virtual machine and provides a controlling function;
an interpreter module which provides an environment for interpreting and running the first task program, which is written in a script language;
a designer module which creates a container for storing an external component that is used in a current task session to expand functionality of the virtual machine;
a system object module which includes objects that are provided to the interpreter module; and
a task module which manages the main module and controls a plurality of tasks.

5. A distributed processing method comprising:
a distributed processing server dividing a task into small tasks and transmitting to each of a plurality of clients a task program, which stores the content of each task session and task data required for each small task; and
one of the plurality of the clients receiving a first task program through a network using a predetermined protocol, loading the first task program onto a virtual machine, receiving first task data to run the first task program, and transmitting a task execution result to the distributed processing server through the network.

6. The method of claim 5, wherein the first task program is written in a script language that can be interpreted by the virtual machine.

7. The method of claim 5, wherein the predetermined protocol is defined by a script language in the first task program.

8. A distributed processing method comprising:
transmitting, with a distributed processing server, to a client, a task program and task data required for the task program of a distributed task, if a task is defined as requiring distributed processing;
loading the task program onto a virtual machine installed in the client;
performing with a macro processor, macro instructions in the loaded task program and performing with a preprocessor, preprocessing;
running with a scripting engine, the task program; and
transmitting with an interpreter engine manager, a task execution result to a session that requested the distributed task and transmitting information required by the distributed processing server to the distributed processing server.

9. The method of claim 8, wherein the task program is written in a script language that can be interpreted by the virtual machine.

10. A virtual machine, which executes distributed processing tasks including a plurality of tasks, comprising:
a main module which manages the virtual machine and provides a controlling function;
an interpreter module which provides an environment for interpreting and running a task program written in a script language;
a designer module which creates a container for storing an external component that is used in a current session to expand functionality of the virtual machine;
a system object module which includes objects that are provided to the interpreter module; and
a task module which manages the main module and controls the plurality of the tasks.

11. The virtual machine of claim 10, wherein the main module includes:
a main process manager which manages the plurality of the tasks that will be executed in each client through sessions and manages a script interpreting process for each of the sessions;
an event processor which receives events created by objects dynamically bound in each of the sessions and transmits the events to the interpreter module, in which the events are interpreted;
a process load balance which adjusts a script interpreting process load for each of the sessions; and
a single process manager which manages one of the sessions and executes a script interpreting process for the one of the sessions.

12. The virtual machine of claim 10, wherein the interpreter module includes:
an interpreter engine manager which interprets a one of the plurality of the tasks requested by the single process manager that is bound in a session object;
a scripting engine which runs the task program written in the script language;
a preprocessor which processes both a conventional syntax used in the virtual machine and a predetermined syntax to expand processing functionality of the virtual machine;
a macro processor which registers a macro code and interprets the registered macro code; and
a script loader which reads an original file, containing the one task that will be executed and converts the original file to a script-source-type file so that the scripting engine can execute the one task.

13. The virtual machine of claim 12, further including an encryption/decryption module which performs an encryption and a decryption operation to maintain the security of the interpreter module.

14. The virtual machine of claim 12, wherein the original file is received from a distributed processing server, other storage devices, or local discs coupled to the Internet, wherein the distributed processing server transmits only information regarding storage locations of original files.

15. The virtual machine of claim 10, wherein the designer module includes:
an event handler which creates event handler events; and
a plurality of object containers which are prepared in each session, each of the plurality of the object containers including a plurality of components, and are accessed from the interpreter module included in each session.

16. The virtual machine of claim 15, wherein each of the object containers includes:
an event dispatcher which receives first events created by the components and transmits the first events to the event handler;
a control extender which enables the components to create the first events; and
Active X components which create the first events.

17. The virtual machine of claim 10, wherein the system object module includes:
a global object which is used throughout the entire virtual machine and commonly accessed by respective sessions or processes;
a local object which manages one session-unit task;
a common storage which is used as data storage in the virtual machine, uses a bound external component, and provides a component interface to an application;
a debug object which is used to detect content, a result, or an error of one of the plurality of the tasks executed in the virtual machine;
a designer object which allows the interpreter module to utilize a user interface function provided by the virtual machine; and
a utility object which provides basic functions and subroutines to the interpreter module.

18. The virtual machine of claim 17, wherein the global object manages basic processes, creates common global variables/objects and carries out process control, creation of and access to a storage of the common global variables, and creation of and access to a storage of the common global objects.

19. The virtual machine of claim 17, wherein the local object carries out loading and execution of a script, creation of a system object, registry access, creation of and access to a storage of a common variable, creation of and access to a storage of a common object, collection of an object, invoker registration, macro registration, creation of and access to a timer object, and message transmission.

20. The virtual machine of claim 10, wherein the task module includes:
the plurality of the tasks registered as register process functions;
a task manager which manages the plurality of the tasks;
a thread manager which executes the plurality of the tasks; and
a task buffer which stores the plurality of the tasks.

21. A computer-readable medium for recording a computer program code for enabling a computer to provide a service of distributed processing, the service comprising:
dividing a task into task sessions and transmitting to each of a plurality of clients a task program, which stores the content of each of the task sessions and task data required for each task; and
processing at each of the plurality of the clients, including receiving the task program through a network using a predetermined protocol, loading the task program onto a virtual machine, receiving the task data to run the task program, and transmitting a task execution result to the distributed processing server through the network.

22. A computer-readable medium for recording a computer program code for enabling a computer to provide a service of distributed processing, the service comprising:
transmitting to a client a task program and task data required for the task program, if a task is defined as requiring distributed processing;
processing at the client including:
loading the task program onto a virtual machine installed in the client;
performing macro instructions in the loaded task program and performing preprocessing;
running the task program with a scripting engine; and
transmitting with an interpreter engine manager, a task execution result to a session that requested the task and transmitting information required by the distributed processing server to the distributed processing server.
